(19) United States
(12) Patent Application Publication
(10) Pub. No.: US 2023/0371055 A1
(43) Pub. Date: Nov. 16, 2023

(54) INDICATING DISTORTION INFORMATION FOR A DIGITAL POST DISTORTION OPERATION

(71) Applicant: QUALCOMM Incorporated, San Diego, CA (US)

(72) Inventors: Ram KRIPS, Ramat Gan (IL); Idan Michael HORN, Hod Hasharon (IL); Gideon Shlomo KUTZ, Ramat Hasharon (IL); Elad MEIR, Ramat Gan (IL); Amit BAR-OR TILLINGER, Tel-Aviv (IL); Assaf TOUBOUL, Netanya (IL)

(21) Appl. No.: 17/663,002

(22) Filed: May 11, 2022

(51) Int. Cl. H04W 72/08; H04B 1/04; H04L 1/24; H04B 17/13; H04B 17/10; H04W 52/24

(52) U.S. Cl. CPC H04W 72/08; H04B 1/0475; H04L 1/248; H04B 17/13; H04B 17/102; H04W 52/243

(57) ABSTRACT

Various aspects of the present disclosure generally relate to wireless communication. In some aspects, a first network node may receive a distortion indication comprising distortion information associated with a signal transmission configuration corresponding to a second network node. The first network node may perform, based at least in part on the distortion information, a digital post distortion (DPoD) operation associated with a signal having a distortion characteristic corresponding to the distortion information. The first network node may communicate with the second network node based at least in part on performing the DPoD operation. Numerous other aspects are provided.

### FIELD OF THE DISCLOSURE

Aspects of the present disclosure generally relate to wireless communication and specifically, to techniques and apparatuses for indicating distortion information for a digital post distortion operation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MB/10) antenna technology, and carrier aggregation. As the demand for mobile broadband access continues to increase, further improvements in LTE, NR, and other radio access technologies remain useful.

Path loss often contributes to challenges with wireless communication. Path loss can be measured, for example, as a decrease in a signal-to-noise ratio (SNR). In some cases, increasing transmission power can compensate for the SNR decrease. However, compensation for SNR decrease by increasing transmission power is typically achieved using peak-to-average-power ratio (PAPR) reduction methods to avoid power amplifier compression. In some cases, for example, PAPR reduction can be achieved by applying a crest factor reduction (CFR) to the transmitted signal before analog to digital conversion. Applying the CFR facilitates an increase in the transmission power, but can reduce the achievable error vector magnitude (EVM) performance, as the CFR can introduce non-linear distortion to the transmitted signal.

### SUMMARY

Some aspects described herein relate to a first network node for wireless communication. The first network node may include at least one processor and at least one memory, communicatively coupled with the at least one processor, that stores processor-readable code. The processor-readable code, when executed by the at least one processor, may be configured to cause the first network node to receive a distortion indication comprising distortion information associated with a signal transmission configuration corresponding to a second network node. The processor-readable code, when executed by the at least one processor, may be configured to cause the first network node to perform, based at least in part on the distortion information, a digital post distortion (DPoD) operation associated with a signal having a distortion characteristic corresponding to the distortion information. The processor-readable code, when executed by the at least one processor, may be configured to cause the first network node to communicate with the second network node based at least in part on performing the DPoD operation.

Some aspects described herein relate to a network node for wireless communication. The network node may include at least one processor and at least one memory, communicatively coupled with the at least one processor, that stores processor-readable code. The processor-readable code, when executed by the at least one processor, may be configured to cause the network node to transmit a distortion indication comprising distortion information associated with a signal transmission configuration. The processor-readable code, when executed by the at least one processor, may be configured to cause the network node to transmit a signal having a distortion characteristic corresponding to the distortion information.

Some aspects described herein relate to a method of wireless communication performed by a first network node. The method may include receiving a distortion indication comprising distortion information associated with a signal transmission configuration corresponding to a second network node. The method may include performing, based at least in part on the distortion information, a DPoD operation associated with a signal having a distortion characteristic corresponding to the distortion information. The method may include communicating with the second network node based at least in part on performing the DPoD operation.

Some aspects described herein relate to a method of wireless communication performed by a network node. The method may include transmitting a distortion indication comprising distortion information associated with a signal transmission configuration. The method may include transmitting a signal having a distortion characteristic corresponding to the distortion information.

Some aspects described herein relate to a non-transitory computer-readable medium that stores a set of instructions for wireless communication by a first network node. The set of instructions, when executed by one or more processors of the first network node, may cause the UE to receive a distortion indication comprising distortion information associated with a signal transmission configuration corresponding to a second network node. The set of instructions, when executed by one or more processors of the first network node, may cause the first network node to perform, based at least in part on the distortion information, a DPoD operation associated with a signal having a distortion characteristic corresponding to the distortion information. The set of instructions, when executed by one or more processors of the first network node, may cause the first network node to communicate with the second network node based at least in part on performing the DPoD operation.

Some aspects described herein relate to a non-transitory computer-readable medium that stores a set of instructions for wireless communication by a network node. The set of instructions, when executed by one or more processors of the network node, may cause the network node to transmit a distortion indication comprising distortion information associated with a signal transmission configuration. The set of instructions, when executed by one or more processors of the network node, may cause the network node to transmit a signal having a distortion characteristic corresponding to the distortion information.

Some aspects described herein relate to an apparatus for wireless communication. The apparatus may include means for receiving a distortion indication comprising distortion information associated with a signal transmission configuration corresponding to a network node. The apparatus may include means for performing, based at least in part on the distortion information, a DPoD operation associated with a signal having a distortion characteristic corresponding to the distortion information. The apparatus may include means for communicating with the network node based at least in part on performing the DPoD operation.

Some aspects described herein relate to an apparatus for wireless communication. The apparatus may include means for transmitting a distortion indication comprising distortion information associated with a signal transmission configuration. The apparatus may include means for transmitting a signal having a distortion characteristic corresponding to the distortion information.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example of an open radio access network architecture, in accordance with the present disclosure.

FIG. 4 is a diagram illustrating an example of indicating distortion information for a digital post distortion (DPoD) operation, in accordance with the present disclosure.

FIG. 5 is a flowchart illustrating an example process performed, for example, by a first network node, in accordance with the present disclosure.

FIG. 6 is a flowchart illustrating an example process performed, for example, by a first network node, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (for example, end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (for example, hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to using known non-linear distortion information associated with a transmitting network node to facilitate performing a digital post distortion (DPoD) operation at a receiving network node to remove non-linear distortion from a signal received from the transmitting network node. Some aspects more specifically relate to transmitting a distortion indication that includes distortion information associated with a signal transmission configuration corresponding to the transmitting network node. In some aspects, the receiving network node may perform, based at least in part on the distortion information, a DPoD operation associated with a signal having a distortion characteristic corresponding to the distortion information. The receiving network node may communicate with the transmitting network node based at least in part on performing the DPoD operation.

Particular aspects of the subject matter described in this disclosure can be implemented to realize one or more of the following potential advantages. In some examples, the described techniques can be used to compensate for known signal distortion using a DPoD having low complexity, as the DPoD operation does not need to be trained. In some examples, the DPoD operation may lead to improved communication performance of network nodes.

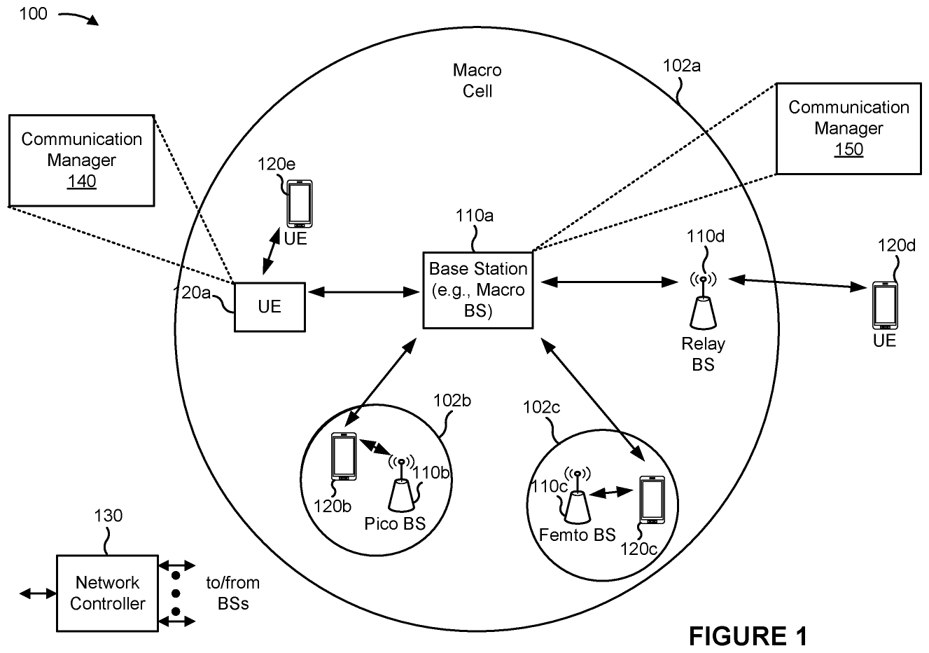

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

As described herein, a network node, which also may be referred to as a “node” or a “wireless node,” may be a base station (for example, base station 110), a UE (for example, UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (for example, a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, a first network node may include a communication manager 140 or a communication manager 150. As described in more detail elsewhere herein, the communication manager 140 or 150 may receive a distortion indication comprising distortion information associated with a signal transmission configuration corresponding to a second network node; perform, based at least in part on the distortion information, a DPoD operation associated with a signal having a distortion characteristic corresponding to the distortion information; and communicate with the network node based at least in part on performing the DPoD operation. Additionally or alternatively, the communication manager 140 or 150 may perform one or more other operations described herein.

In some aspects, a network node may include a communication manager 140 or a communication manager 150. As described in more detail elsewhere herein, the communication manager 140 or 150 may transmit a distortion indication comprising distortion information associated with a signal transmission configuration; and transmit a signal having a distortion characteristic corresponding to the distortion information. Additionally or alternatively, the communication manager 140 or 150 may perform one or more other operations described herein.

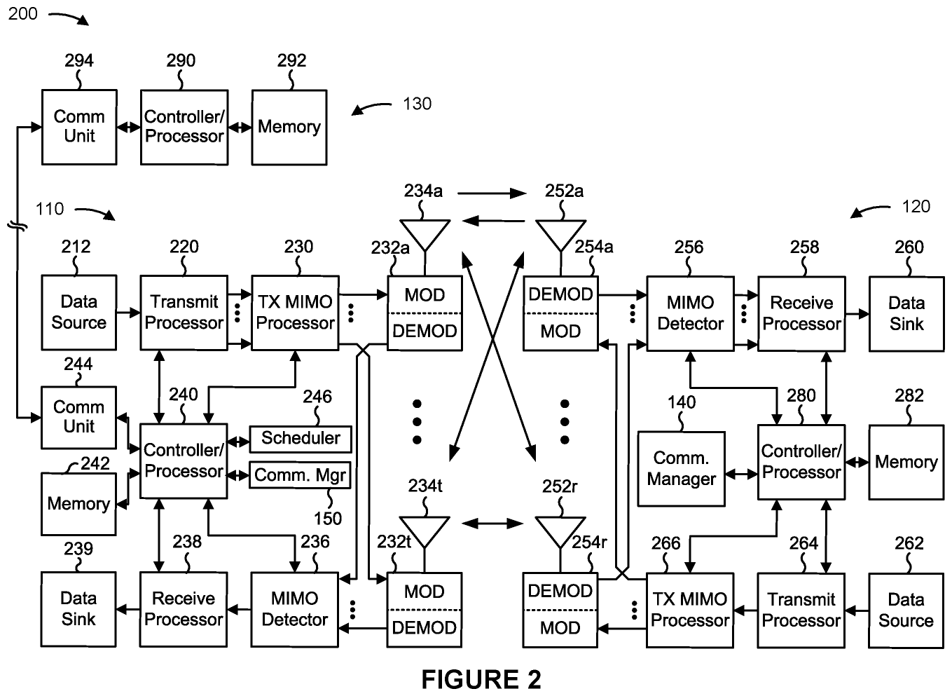

FIG. 2 is a diagram illustrating an example base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

In some aspects, the term “base station” (for example, the base station 110), “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a centralized unit (CU), a distributed unit (DU), a radio unit (RU), a Near-Real Time (Near-RT) RAN Intelligent Controller (MC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

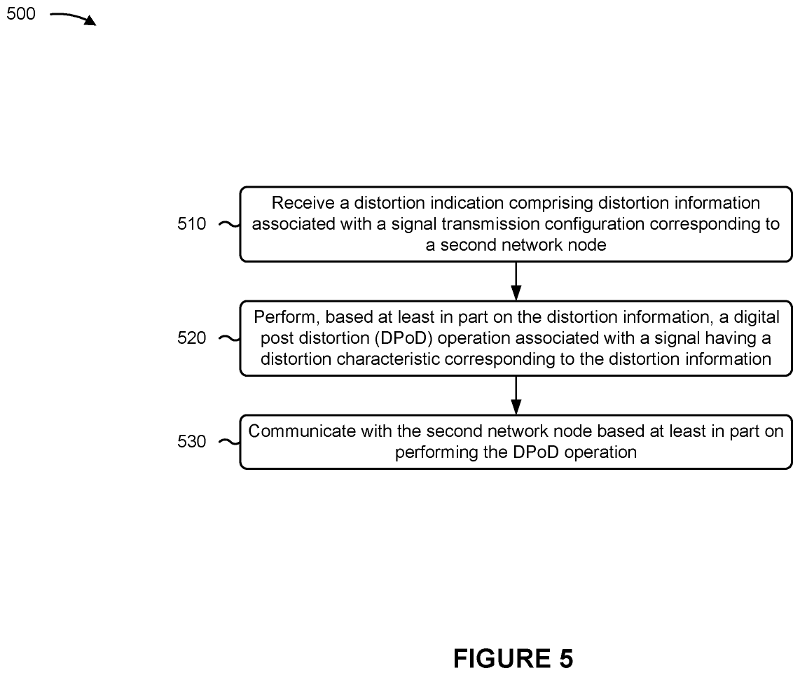

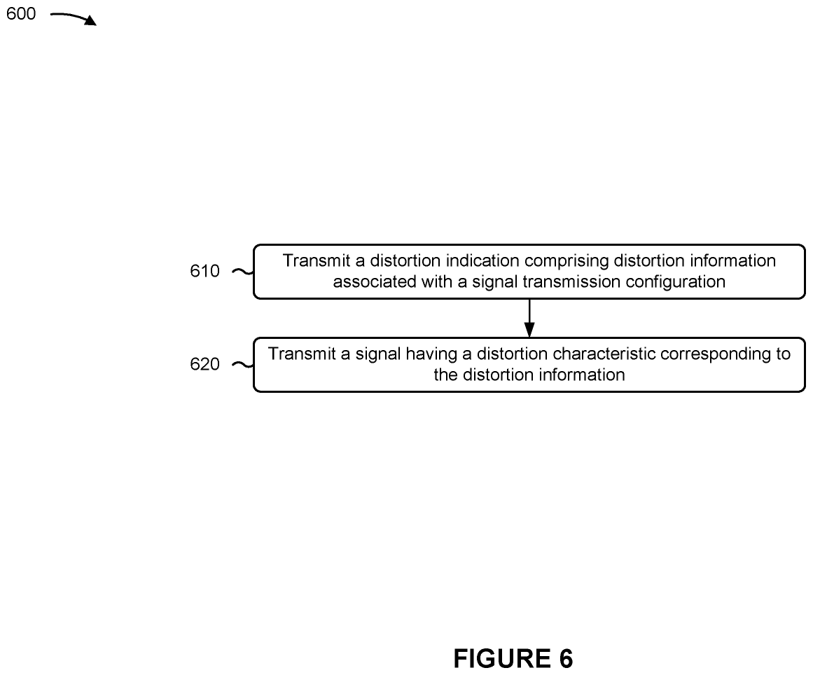

The controller/processor 240 of the base station 110, the controller/processor 280 of the UE 120, or any other component(s) of FIG. 2 may perform one or more techniques associated with indicating distortion information for a DPoD operation, as described in more detail elsewhere herein. In some aspects, the network node described herein is the base station 110, is included in the base station 110, or includes one or more components of the base station 110 shown in FIG. 2. For example, the controller/processor 240 of the base station 110, the controller/processor 280 of the UE 120, or any other component(s) of FIG. 2 may perform or direct operations of, for example, process 500 of FIG. 5, process 600 of FIG. 6, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 500 of FIG. 5, process 600 of FIG. 6, or other processes as described herein. In some examples, executing instructions may include running the instructions, converting the instructions, compiling the instructions, or interpreting the instructions, among other examples.

In some aspects, a first network node includes means for receiving a distortion indication comprising distortion information associated with a signal transmission configuration corresponding to a second network node; means for performing, based at least in part on the distortion information, a DPoD operation associated with a signal having a distortion characteristic corresponding to the distortion information; and/or means for communicating with the second network node based at least in part on performing the DPoD operation. The means for the first network node to perform operations described herein may include, for example, one or more of communication manager 140, antenna 252, modem 254, MIMO detector 256, receive processor 258, transmit processor 264, TX MIMO processor 266, controller/processor 280, or memory 282. In some aspects, the means for the first network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network node includes means for transmitting a distortion indication comprising distortion information associated with a signal transmission configuration; and/or means for transmitting a signal having a distortion characteristic corresponding to the distortion information. The means for the network node to perform operations described herein may include, for example, one or more of communication manager 140, antenna 252, modem 254, MIMO detector 256, receive processor 258, transmit processor 264, TX MIMO processor 266, controller/processor 280, or memory 282. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, gNB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

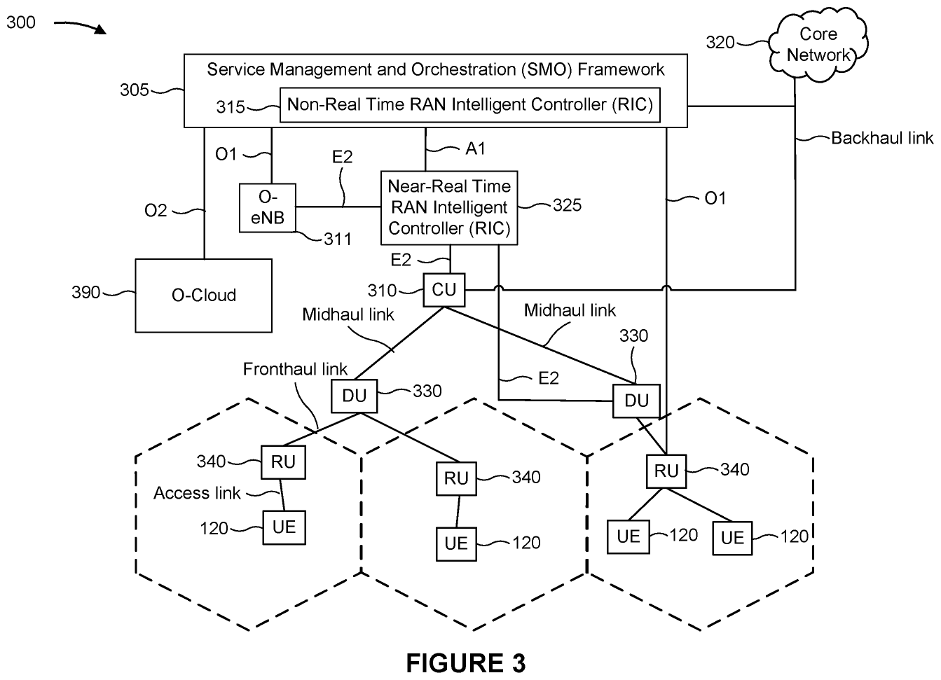

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT MC 325.

In some implementations, to generate AI/ML models to be deployed in the Near-RT MC 325, the Non-RT MC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

Path loss often contributes to challenges with wireless communication. Path loss can be measured, for example, as a decrease in a signal-to-noise ratio (SNR). Increasing transmission power increases the signal received at the receiving device, which cause an increase in the SNR. However, increasing transmission power is typically achieved using peak-to-average-power ratio (PAPR) reduction methods to avoid power amplifier compression. In some cases, for example, PAPR reduction can be achieved by applying a crest factor reduction (CFR) to the transmitted signal before analog to digital conversion. Applying the CFR facilitates an increase in the transmission power, but can reduce the achievable error vector magnitude (EVM) performance, as the CFR can introduce non-linear distortion to the transmitted signal. In some cases, a receiving network node can use a DPoD based on an estimated non-linear distortion. However, estimating the non-linear distortion can lead to inaccuracies in the removal, by the DPoD, of estimated non-linear distortion from a received signal. Additionally, estimating non-linear distortion can result in significant computational overhead, thereby consuming computing resources and power, as well as introducing inefficiencies to network communications.

Some aspects of the techniques and apparatuses described herein may provide a DPoD operation at a first network node that may be used to remove the non-linear distortion introduced by a second network node. The non-linear distortion may be a known non-linear distortion. For example, in contrast to cases in which the non-linear distortion is estimated by the receiving network node, some aspects facilitate indicating distortion information corresponding to the non-linear distortion to the receiving network node, which uses the distortion information (e.g., the known non-linear distortion) to perform the DPoD operation. In this way, non-linear distortions may be removed from received signals without incurring the computational overhead, and associated negative impacts, of estimating the non-linear distortion. In some aspects, for example, the second network node may transmit a distortion indication to the first network node. The distortion indication may include distortion information associated with the transmission power adjustment parameters that the second network node may use. The first network node may perform the DPoD operation on a received signal based at least in part on the distortion information. In this way, for example, some aspects, may restore EVM by removing non-linear distortions created by the CFR, thereby resulting in a higher quality, high PAPR transmission signal reconstruction at the first network node. As a result, some aspects may positively impact signal reception and, therefore, network node and/or network performance.

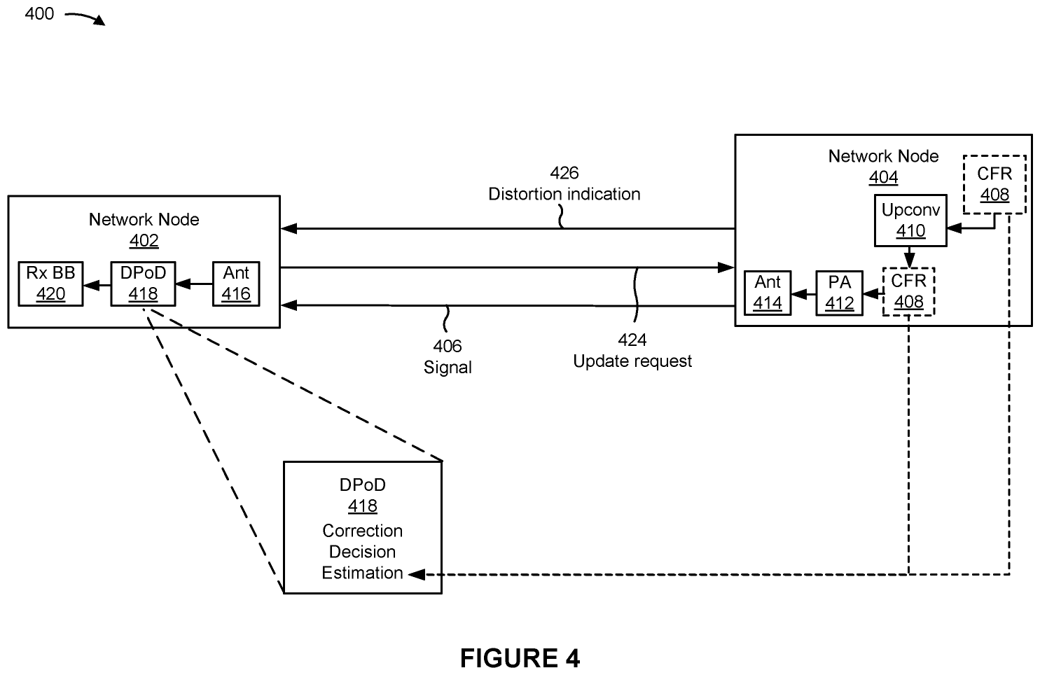

FIG. 4 is a diagram illustrating an example 400 A indicating distortion information for a DPoD operation, in accordance with the present disclosure. As shown in FIG. 4, a network node 402 and a network node 404 may communicate with one another. The network node 402 and/or the network node 404 may be, include, or be included in, a UE (e.g., the UE 120 depicted in FIGS. 1 and 2), a base station (e.g., the base station 110 depicted in FIGS. 1 and 2), and/or one or more components of a disaggregated base station architecture (e.g., the disaggregated base station architecture 300 depicted in FIG. 3). In some aspects, the network node 402 may be referred to as a first network node, and the network node 404 may be referred to as a second network node (e.g., in descriptions associated with a perspective corresponding to the network node 402). In some other aspects, the network node 404 may be referred to as a first network node, and the network node 402 may be referred to as a second network node (e.g., in descriptions associated with a perspective corresponding to the network node 404).

In an operation 406, the network node 404 may transmit, and the network node 402 may receive, a signal. To transmit the signal, the network node 404 may process a generated transmission signal using a CFR process 408 that may provide a power adjustment to the transmission signal prior to an upconversion process 410. In some cases, as shown, the CFR process 408 can follow the upconversion process 410. As shown, the network node 404 may amplify the upconverted signal using a power amplifier (PA) 412 and transmit the amplified signal using an antenna (shown as “ant”) 414. The network node 402 may receive the signal using an antenna 416 and may use a DPoD operation 418 to remove non-linear distortions introduced by the CFR process 408. The resulting signal may then be further processed by the base band reception (Rx) process 420. In some aspects, the network node 402 may be configured, by the network node 404, with a CFR process 408 and/or CFR parameters to be used.

As described above, the CFR may introduce non-linear distortion to the signal and the DPoD operation 418 may be configured to remove that non-linear distortion. For example, the DPoD operation 418 may include an estimation, \hat{d}ₓ=CFR(\hat{x})−\hat{x}, of the non-linear distortion based at least in part on information associated with the power adjustment parameters (for example, CFR parameters and/or other parameters) used by the network node 404. A slicer operation may be used to perform a decision, \hat{x}=Slicer(ycorrected), for removing the non-linear distortion. The network node 402 may remove the non-linear distortion using a correction, where ycorrected=y− [symbol] .

To facilitate the DPoD operation, in an operation 424, the network node 402 may transmit, and the network node 404 may receive, an update request. In some aspects, for example, the update request may be associated with a CFR threshold.

In an operation 426, the network node 404 may transmit, and the network node 402 may receive, a distortion indication. In some aspects, for example, the network node 402 may be a UE (for example, the UE 120 depicted in FIGS. 1 and 2) and the network node 404 may be a base station, one or more components of a disaggregated base station, and/or a relay device, among other examples. The network node 404 may provide the distortion indication to the network node 402 to indicate information about the non-linear distortion that may be used by the network node 402 to facilitate removing the non-linear distortion. In some aspects, the network node 404 may transmit the distortion indication based at least in part on receiving the update request. In some other aspects, the network node 404 may transmit the distortion indication without receiving an update request (for example, in some cases, the network node 402 may not transmit an update request).

In some aspects, the distortion indication may include distortion information associated with a signal transmission configuration corresponding to the network node 404. The distortion information may include non-linearity information associated with a non-linearity model. In some aspects, the distortion information may include an indication that the network node 404 is using a power adjustment that will introduce non-linear distortion. In some aspects, the distortion information may include an indication of a CFR method that the network node 404 uses to adjust signal power. In some aspects, the distortion information may include an indication of a CFR model that represents the non-linear distortion introduced by the CFR method.

In some aspects, the distortion information may include one or more transmission power adjustment parameters. For example, the one or more transmission power adjustment parameters may indicate at least one CFR parameter. The at least one CFR parameter may correspond to at least one CFR model and the at least one CFR model may include at least one of a polar model associated with an absolute value of a base band signal of a signal to be transmitted by the network node 404 or a digital-to-analog converter (DAC) Cartesian optimized CFR model associated with a real part and an imaginary part of the base band signal. In some aspects, the CFR model may be any other type of CFR model that may facilitate adjusting a signal power. In some aspects, the distortion information may indicate an update associated with the non-linearity model. For example, in some aspects, the update may include a change from a first non-linearity type to a second non-linearity type.

In some aspects, the network node 402 may perform the DPoD operation 418 based at least in part on the distortion information. In some aspects, for example, the network node 402 may determine a non-linearity model estimate corresponding to the non-linearity model. The distortion information may indicate an update associated with the non-linearity model. In some aspects, the network node 402 may determine an updated non-linearity model estimate based at least in part on the update. In some aspects, performing the DPoD operation may include determining a CFR parameter and/or determining an updated CFR parameter based at least in part on the update. The update request may indicate the CFR parameter.

In some implementations, the network node 404 may be a UE (for example, the UE 120 depicted in FIGS. 1 and 2) and the network node 402 may be a base station, one or more components of a disaggregated base station, and/or a relay device, among other examples. The network node 402 may provide, via the distortion indication, distortion information that may indicate one or more power adjustment models, methods, and/or parameters that may be used by the network node 404 to perform a power adjustment when transmitting the signal. The network node 404 may perform the power adjustment based on the distortion information received from the network node 402 and, in this way, the network node 402 may perform the DPoD operation discussed herein based on the distortion information. For example, in some aspects, the network node 402 may transmit, and the network node 404 may receive, a distortion indication that includes a CFR method and/or one or more CFR parameters. The network node 404 may transmit the signal, after applying the CFR method and/or the one or more CFR parameters, and the network node 402 may perform the DPoD 418 based on the CFR method and/or one or more CFR parameters, as described herein.

FIG. 5 is a flowchart illustrating an example process 500 performed, for example, by a first network node in accordance with the present disclosure. Example process 500 is an example where the first network node (for example, network node 402) performs operations associated with indicating distortion information for a DPoD operation.

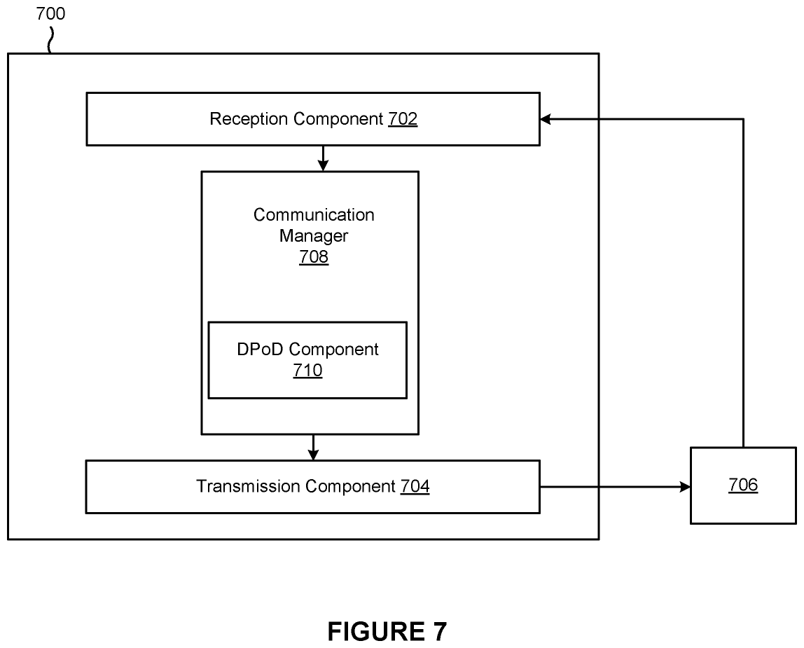

As shown in FIG. 5, in some aspects, process 500 may include receiving a distortion indication comprising distortion information associated with a signal transmission configuration corresponding to a second network node (block 510). For example, the first network node (such as by using communication manager 708 or reception component 702, depicted in FIG. 7) may receive a distortion indication comprising distortion information associated with a signal transmission configuration corresponding to a second network node, as described above.

As further shown in FIG. 5, in some aspects, process 500 may include performing, based at least in part on the distortion information, a DPoD operation associated with a signal having a distortion characteristic corresponding to the distortion information (block 520). For example, the first network node (such as by using communication manager 708 or DPoD component 710, depicted in FIG. 7) may perform, based at least in part on the distortion information, a DPoD operation associated with a signal having a distortion characteristic corresponding to the distortion information, as described above.

As further shown in FIG. 5, in some aspects, process 500 may include communicating with the network node based at least in part on performing the DPoD operation (block 530). For example, the first network node (such as by using communication manager 708, reception component 702, and/or transmission component 704, depicted in FIG. 7) may communicate with the network node based at least in part on performing the DPoD operation, as described above.

Process 500 may include additional aspects, such as any single aspect or any combination of aspects described below or in connection with one or more other processes described elsewhere herein.

In a first additional aspect, process 500 includes receiving the signal. In a second additional aspect, alone or in combination with the first aspect, the distortion information comprises at least one CFR method. In a third additional aspect, alone or in combination with one or more of the first and second aspects, the distortion information comprises one or more transmission power adjustment parameters. In a fourth additional aspect, alone or in combination with the third aspect, the one or more transmission power adjustment parameters indicate at least one CFR parameter. In a fifth additional aspect, alone or in combination with the fourth aspect, the at least one CFR parameter corresponds to at least one CFR model. In a sixth additional aspect, alone or in combination with the fifth aspect, the at least one CFR model comprises at least one of a polar model associated with an absolute value of a base band signal of the signal or a DAC Cartesian optimized CFR model associated with a real part of the base band signal and an imaginary part of the base band signal.

In a seventh additional aspect, alone or in combination with one or more of the first through sixth aspects, the distortion information comprises non-linearity information associated with a non-linearity model. In an eighth additional aspect, alone or in combination with the seventh aspect, process 500 includes determining a non-linearity model estimate corresponding to the non-linearity model. In a ninth additional aspect, alone or in combination with one or more of the seventh or eighth aspects, the distortion information indicates an update associated with the non-linearity model.

In a tenth additional aspect, alone or in combination with the ninth aspect, the update comprises a change from a first non-linearity type to a second non-linearity type. In an eleventh additional aspect, alone or in combination with one or more of the ninth or tenth aspects, process 500 includes determining an updated non-linearity model estimate based at least in part on the update. In a twelfth additional aspect, alone or in combination with one or more of the ninth through eleventh aspects, performing the DPoD operation comprises determining a CFR parameter, and process 500 further includes determining an updated CFR parameter based at least in part on the update. In a thirteenth additional aspect, alone or in combination with the twelfth aspect, process 500 includes transmitting an update request associated with the CFR parameter, and receiving the distortion indication comprises receiving the distortion indication based at least in part on transmitting the update request. In a fourteenth additional aspect, alone or in combination with one or more of the twelfth or thirteenth aspects, the update request indicates the CFR parameter.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, by a network node in accordance with the present disclosure. Example process 600 is an example where the network node (for example, network node 404) performs operations associated with indicating distortion information for a DPoD operation.

As shown in FIG. 6, in some aspects, process 600 may include transmitting a distortion indication comprising distortion information associated with a signal transmission configuration (block 610). For example, the network node (such as by using communication manager 708 or transmission component 704, depicted in FIG. 7) may transmit a distortion indication comprising distortion information associated with a signal transmission configuration, as described above.

As further shown in FIG. 6, in some aspects, process 600 may include transmitting a signal having a distortion characteristic corresponding to the distortion information (block 620). For example, the network node (such as by using communication manager 708 or transmission component 704, depicted in FIG. 7) may transmit a signal having a distortion characteristic corresponding to the distortion information, as described above.

Process 600 may include additional aspects, such as any single aspect or any combination of aspects described below or in connection with one or more other processes described elsewhere herein.

In a first additional aspect, the distortion information comprises an indication of a CFR method. In a second additional aspect, alone or in combination with the first aspect, the distortion information comprises one or more transmission power adjustment parameters. In a third additional aspect, alone or in combination with the second aspect, the one or more transmission power adjustment parameters indicate at least one CFR parameter. In a fourth additional aspect, alone or in combination with the third aspect, the at least one CFR parameter corresponds to at least one CFR model. In a fifth additional aspect, alone or in combination with the fourth aspect, the at least one CFR model comprises at least one of a polar model associated with an absolute value of a base band signal of the signal or a DAC Cartesian optimized CFR model associated with a real part of the base band signal and an imaginary part of the base band signal.

In a sixth additional aspect, alone or in combination with one or more of the first through fifth aspects, the distortion information comprises non-linearity information associated with a non-linearity model. In a seventh additional aspect, alone or in combination with the sixth aspect, the distortion information indicates an update associated with the non-linearity model. In an eighth additional aspect, alone or in combination with the seventh aspect, the update comprises a change from a first non-linearity type to a second non-linearity type.

In a ninth additional aspect, alone or in combination with one or more of the first through eighth aspects, process 600 includes receiving an update request associated with a CFR parameter, and transmitting the distortion indication comprises transmitting the distortion indication based at least in part on receiving the update request. In a tenth additional aspect, alone or in combination with the ninth aspect, the update request indicates the CFR parameter.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication. The apparatus 700 may be a network node, or a network node may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a communication manager 708. The communication manager 708 may include a DPoD component 710.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5, process 600 of FIG. 6, or a combination thereof. In some aspects, the apparatus 700 and/or one or more components shown in FIG. 7 may include one or more components of the UE and/or the base station 110 described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE and/or the base station 110 described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE and/or the base station 110 described in connection with FIG. 2. In some aspects, the transmission component 704 may be co-located with the reception component 702 in a transceiver.

The reception component 702 may receive a distortion indication comprising distortion information associated with a signal transmission configuration corresponding to a second network node. The communication manager 708 and/or the DPoD component 710 may perform, based at least in part on the distortion information, a DPoD operation associated with a signal having a distortion characteristic corresponding to the distortion information. In some aspects, the communication manager 708 may include one or more antennas, a modem, a controller/processor, a memory, or a combination thereof, of the UE and/or the base station 110 described in connection with FIG. 2. In some aspects, the communication manager 708 may include the reception component 702 and/or the transmission component 704. In some aspects, the communication manager may be, be similar to, include, or be included in, the communication manager 140 and/or the communication manager 150, depicted in FIGS. 1 and 2. In some aspects, the DPoD component 710 may include one or more antennas, a modem, a controller/processor, a memory, or a combination thereof, of the UE and/or the base station 110 described in connection with FIG. 2. In some aspects, the DPoD component 710 may include the reception component 702 and/or the transmission component 704.

The communication manager 708, the reception component 702, and/or the transmission component 704 may communicate with the network node based at least in part on performing the DPoD operation. The reception component 702 may receive the signal. The communication manager 708 and/or the DPoD component 710 may determine a non-linearity model estimate corresponding to the non-linearity model. The communication manager 708 and/or the DPoD component 710 may determine an updated non-linearity model estimate based at least in part on the update. The transmission component 704 may transmit an update request associated with the CFR parameter, and receiving the distortion indication comprises receiving the distortion indication based at least in part on transmitting the update request.

The transmission component 704 may transmit a distortion indication comprising distortion information associated with a signal transmission configuration. The transmission component 704 may transmit a signal having a distortion characteristic corresponding to the distortion information. The reception component 702 may receive an update request associated with a CFR parameter, and transmitting the distortion indication comprises transmitting the distortion indication based at least in part on receiving the update request.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a first network node, comprising: receiving a distortion indication comprising distortion information associated with a signal transmission configuration corresponding to a second network node; performing, based at least in part on the distortion information, a digital post distortion (DPoD) operation associated with a signal having a distortion characteristic corresponding to the distortion information; and communicating with the network node based at least in part on performing the DPoD operation.

Aspect 2: The method of Aspect 1, further comprising receiving the signal.

Aspect 3: The method of either of Aspects 1 or 2, wherein the distortion information comprises at least one crest factor reduction (CFR) method.

Aspect 4: The method of any of Aspects 1-3, wherein the distortion information comprises one or more transmission power adjustment parameters.

Aspect 5: The method of Aspect 4, wherein the one or more transmission power adjustment parameters indicate at least one crest factor reduction (CFR) parameter.

Aspect 6: The method of Aspect 5, wherein the at least one CFR parameter corresponds to at least one CFR model.

Aspect 7: The method of Aspect 6, wherein the at least one CFR model comprises at least one of a polar model associated with an absolute value of a base band signal of the signal or a digital-to-analog converter (DAC) Cartesian optimized CFR model associated with a real part of the base band signal and an imaginary part of the base band signal.

Aspect 8: The method of any of Aspects 1-7, wherein the distortion information comprises non-linearity information associated with a non-linearity model.

Aspect 9: The method of Aspect 8, further comprising determining a non-linearity model estimate corresponding to the non-linearity model.

Aspect 10: The method of either of Aspects 8 or 9, wherein the distortion information indicates an update associated with the non-linearity model.

Aspect 11: The method of Aspect 10, wherein the update comprises a change from a first non-linearity type to a second non-linearity type.

Aspect 12: The method of either of Aspects 10 or 11, further comprising determining an updated non-linearity model estimate based at least in part on the update.

Aspect 13: The method of any of Aspects 10-12, wherein performing the DPoD operation comprises determining a crest factor reduction (CFR) parameter, the method further comprising determining an updated CFR parameter based at least in part on the update.

Aspect 14: The method of Aspect 13, further comprising transmitting an update request associated with the CFR parameter, and wherein receiving the distortion indication comprises receiving the distortion indication based at least in part on transmitting the update request.

Aspect 15: The method of either of Aspects 13 or 14, wherein the update request indicates the CFR parameter.

Aspect 16: A method of wireless communication performed by a network node, comprising: transmitting a distortion indication comprising distortion information associated with a signal transmission configuration; and transmitting a signal having a distortion characteristic corresponding to the distortion information.

Aspect 17: The method of Aspect 16, wherein the distortion information comprises an indication of a crest factor reduction (CFR) method.

Aspect 18: The method of either of Aspects 16 or 17, wherein the distortion information comprises one or more transmission power adjustment parameters.

Aspect 19: The method of Aspect 18, wherein the one or more transmission power adjustment parameters indicate at least one crest factor reduction (CFR) parameter.

Aspect 20: The method of Aspect 19, wherein the at least one CFR parameter corresponds to at least one CFR model.

Aspect 21: The method of Aspect 20, wherein the at least one CFR model comprises at least one of a polar model associated with an absolute value of a base band signal of the signal or a digital-to-analog converter (DAC) Cartesian optimized CFR model associated with a real part of the base band signal and an imaginary part of the base band signal.

Aspect 22: The method of any of Aspects 16-21, wherein the distortion information comprises non-linearity information associated with a non-linearity model.

Aspect 23: The method of Aspect 22, wherein the distortion information indicates an update associated with the non-linearity model.

Aspect 24: The method of Aspect 23, wherein the update comprises a change from a first non-linearity type to a second non-linearity type.

Aspect 25: The method of any of Aspects 16-24, further comprising receiving an update request associated with a crest factor reduction (CFR) parameter, and wherein transmitting the distortion indication comprises transmitting the distortion indication based at least in part on receiving the update request.

Aspect 26: The method of Aspect 25, wherein the update request indicates the CFR parameter.

Aspect 27: An apparatus for wireless communication at a device, comprising a processor; memory coupled with the processor; and instructions stored in the memory and executable by the processor to cause the apparatus to perform the method of one or more of Aspects 1-15.

Aspect 28: A device for wireless communication, comprising a memory and one or more processors coupled to the memory, the one or more processors configured to perform the method of one or more of Aspects 1-15.

Aspect 29: An apparatus for wireless communication, comprising at least one means for performing the method of one or more of Aspects 1-15.

Aspect 30: A non-transitory computer-readable medium storing code for wireless communication, the code comprising instructions executable by a processor to perform the method of one or more of Aspects 1-15

Aspect 31: A non-transitory computer-readable medium storing a set of instructions for wireless communication, the set of instructions comprising one or more instructions that, when executed by one or more processors of a device, cause the device to perform the method of one or more of Aspects 1-15.

Aspect 32: An apparatus for wireless communication at a device, comprising a processor; memory coupled with the processor; and instructions stored in the memory and executable by the processor to cause the apparatus to perform the method of one or more of Aspects 16-26.

Aspect 33: A device for wireless communication, comprising a memory and one or more processors coupled to the memory, the one or more processors configured to perform the method of one or more of Aspects 16-26.

Aspect 34: An apparatus for wireless communication, comprising at least one means for performing the method of one or more of Aspects 16-26.

Aspect 35: A non-transitory computer-readable medium storing code for wireless communication, the code comprising instructions executable by a processor to perform the method of one or more of Aspects 16-26.

Aspect 36: A non-transitory computer-readable medium storing a set of instructions for wireless communication, the set of instructions comprising one or more instructions that, when executed by one or more processors of a device, cause the device to perform the method of one or more of Aspects 16-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, since those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A first network node for wireless communication, comprising:
at least one memory; and
at least one processor communicatively coupled with the at least one memory, the at least one processor configured to cause the first network node to:
receive a distortion indication comprising distortion information associated with a signal transmission configuration corresponding to a second network node;
perform, based at least in part on the distortion information, a digital post distortion (DPoD) operation associated with a signal having a distortion characteristic corresponding to the distortion information; and
communicate with the second network node based at least in part on performing the DPoD operation.

2. The first network node of claim 1, wherein the at least processor is further configured to cause the first network node to receive the signal.

3. The first network node of claim 1, wherein the distortion information comprises an indication of a crest factor reduction (CFR) method.

4. The first network node of claim 1, wherein the distortion information comprises one or more transmission power adjustment parameters.

5. The first network node of claim 4, wherein the one or more transmission power adjustment parameters indicate at least one crest factor reduction (CFR) parameter, wherein the at least one CFR parameter corresponds to at least one CFR model.

6. The first network node of claim 5, wherein the at least one CFR model comprises at least one of a polar model associated with an absolute value of a base band signal of the signal or a digital-to-analog converter (DAC) Cartesian optimized CFR model associated with a real part of the base band signal and an imaginary part of the base band signal.

7. The first network node of claim 1, wherein the distortion information comprises non-linearity information associated with a non-linearity model.

8. The first network node of claim 7, wherein the at least processor is further configured to cause the first network node to determine a non-linearity model estimate corresponding to the non-linearity model.

9. The first network node of claim 7, wherein the distortion information indicates an update associated with the non-linearity model.

10. The first network node of claim 9, wherein the update comprises a change from a first non-linearity type to a second non-linearity type.

11. The first network node of claim 9, wherein the at least processor is further configured to cause the first network node to determine an updated non-linearity model estimate based at least in part on the update.

12. The first network node of claim 9, wherein, to cause the first network node to perform the DPoD operation, the at least one processor is configured to cause the first network node to determine a crest factor reduction (CFR) parameter, and wherein the at least one processor is configured to cause the first network node to determine an updated CFR parameter based at least in part on the update.

13. The first network node of claim 12, wherein the at least processor is further configured to cause the first network node to transmit an update request associated with the CFR parameter, and wherein, to cause the first network node to receive the distortion indication, the at least one processor is configured to cause the first network node to receive the distortion indication based at least in part on transmitting the update request.

14. The first network node of claim 13, wherein the update request indicates the CFR parameter.

15. A network node for wireless communication, comprising:
at least one memory; and
at least one processor communicatively coupled with the at least one memory, the at least one processor configured to cause the network node to:
transmit a distortion indication comprising distortion information associated with a signal transmission configuration; and
transmit a signal having a distortion characteristic corresponding to the distortion information.

16. The network node of claim 15, wherein the distortion information comprises an indication of a crest factor reduction (CFR) method.

17. The network node of claim 15, wherein the distortion information comprises one or more transmission power adjustment parameters.

18. The network node of claim 17, wherein the one or more transmission power adjustment parameters indicate at least one crest factor reduction (CFR) parameter, wherein the at least one CFR parameter corresponds to at least one CFR model.

19. The network node of claim 18, wherein the at least one CFR model comprises at least one of a polar model associated with an absolute value of a base band signal of the signal or a digital-to-analog converter (DAC) Cartesian optimized CFR model associated with a real part of the base band signal and an imaginary part of the base band signal.

20. The network node of claim 15, wherein the distortion information comprises non-linearity information associated with a non-linearity model.

21. The network node of claim 20, wherein the distortion information indicates an update associated with the non-linearity model.

22. The network node of claim 21, wherein the update comprises a change from a first non-linearity type to a second non-linearity type.

23. The network node of claim 15, wherein the at least processor is further configured to cause the network node to receive an update request associated with an a crest factor reduction (CFR) parameter, and wherein, to transmit the distortion indication, the at least one processor is configured to cause the network node to transmit the distortion indication based at least in part on receiving the update request.

24. The network node of claim 23, wherein the update request indicates the CFR parameter.

25. A method of wireless communication performed by a first network node, comprising:
receiving a distortion indication comprising distortion information associated with a signal transmission configuration corresponding to a second network node;
performing, based at least in part on the distortion information, a digital post distortion (DPoD) operation associated with a signal having a distortion characteristic corresponding to the distortion information; and
communicating with the second network node based at least in part on performing the DPoD operation.

26. The method of claim 25, wherein the distortion information comprises one or more transmission power adjustment parameters.

27. The method of claim 25, wherein the distortion information comprises non-linearity information associated with a non-linearity model.

28. A method of wireless communication performed by a network node, comprising:
transmitting a distortion indication comprising distortion information associated with a signal transmission configuration; and
transmitting a signal having a distortion characteristic corresponding to the distortion information.

29. The method of claim 28, wherein the distortion information comprises one or more transmission power adjustment parameters.

30. The method of claim 28, wherein the distortion information comprises non-linearity information associated with a non-linearity model.
